(19) United States
(12) Patent Application Publication
(10) Pub. No.: US 2012/0239727 A1
(43) Pub. Date: Sep. 20, 2012

(54) MULTIMEDIA SERVICE NETWORK AND METHOD FOR PROVIDING THE SAME

(75) Inventors: Ashutosh Dutta, Bridgewater, NJ (US); Christian Makaya, New Brunswick, NJ (US); Dana Chee, Maplewood, NJ (US); Fuchun Joseph Lin, Morris Plains, NJ (US); Satoshi Komorita, Saitama (JP); Tsunehiko Chiba, Saitama (JP); Hidetoshi Yokota, Saitama (JP); Benjamin Falchuk, Upper Nyack, NY (US); Manabu Ito, Tokyo (JP)

(73) Assignees: KDDI CORPORATION, Chiyoda-ku (JP); TELCORDIA TECHNOLOGIES, INC., Piscataway, NJ (US)

(21) Appl. No.: 13/049,194

(22) Filed: Mar. 16, 2011

(51) Int. Cl. G06F 15/16

(52) U.S. Cl. 709/203

(57) ABSTRACT

An overlay service network and method for delivering a multimedia service. The overlay service network comprises a user interface for subscribers to request an available service as a requested service, a register server for registering and storing a database of available services, a plurality of service nodes for executing at least one available service and a controller for receiving a request for an available service, searching the register server for the requested service, selecting one or more of the plurality of service nodes to execute the requested service and establishing a chaining sequence between a node requesting the service, the one or more selected execution nodes and a destination node to execute the requested service.

### CROSS-REFERENCE TO RELATED APPLICATIONS AND CLAIM OF PRIORITY

This application is related to and claims the benefit of and priority to U.S. provisional application Ser. No. 61/315,654 filed on Mar. 19, 2010 the entirety of which is incorporated by reference. This application is also related to and claims the benefit of and priority to U.S. provisional application Ser. No. 61/360,634 file Jul. 1, 2010 the entirety of which is incorporated by reference.

### BACKGROUND

NGSON (Next-Generation Service Overlay Networks) specifies context-aware, dynamically adaptive, and self-organizing networking capabilities including advanced service and transport level routing/forwarding schemes that are independent of the underlying networks (i.e., underlying network may be IMS, P2P, legacy IP, or Web). NGSON architecture, which is IEEE P1903, is incorporated by reference as if the entire description was set forth herein in detail. NGSON is intended to benefit network operators, service and content providers, and end-users, allowing them, in turn, to both provide and use collaborative services.

Although NGSON proposes a new paradigm for service overlay networks, several aspects and issues remain open challenges. NGSON does not enable smooth integration with existing technology such as IMS, P2P, SOA, and Web 2.0. Furthermore, NGSON does not define how objects involved in the service are themselves manipulated or transformed, is not bearer-aware, and does not deal with object manipulation (e.g., read, create, modify, convert).

### SUMMARY OF THE INVENTION

Disclosed is a multimedia overlay service network comprising a user interface for subscribers to request an available service as a requested service, a register server for registering and storing a database of available services, a plurality of execution nodes for executing at least one available service and a controller for receiving a request for an available service, searching the register server for the requested service, selecting one or more of the plurality of execution nodes to execute the requested service and establishing a chaining sequence between a node requesting the service, the one or more selected execution nodes and a destination node to execute the requested service. The controller continuously monitors the status of the execution of the requested service for any problems.

The multimedia overlay service network further comprises a plurality of object servers for storing objects which is subject to the available services. Each object server can stores at least one object corresponding to an available service. The controller selects a corresponding object server from the plurality of object servers and establishes a chaining sequence between at least the corresponding object server, the one or more selected execution nodes and a destination node.

The multimedia overlay service network further comprises a user profile node configured to maintain an active list of user profiles for subscribers and a list of capabilities for user equipment. The user profile node is further configured to store network capabilities and node capabilities for user equipment at the destination node. The node capabilities include at least an object format capability for user equipment at the destination node. The network capabilities include available bandwidth.

The multimedia overlay service network further comprises a developer interface configured to provision services in the register server as available services. Each provisioned service is indexed.

The multimedia overlay service network further comprises a ranking service for prioritizing the available services.

The available service can be a simple service or a composite service. A composite service is executed by more than one of the plurality of execution nodes.

The multimedia overlay service network further comprises a script interface for a user to provision a script for the composite service. The composite service is an aggregate of at least two other available services. The script provides an order for chaining the at least two other available services.

The objects are a multi-media file. The multi-media files can be audio, video such as a streaming video or a standing picture such as a photograph.

When the node requesting the available service contains a multi-media file, the controller establishes a chaining sequence between the node requesting the service (which becomes the object server for the requested service), the one or more selected execution nodes and a destination node.

When the node requesting the available service requests a service to stream a video, the controller establishes a chaining sequence between the node requesting the service (which becomes the destination node for said requested service), the one or more selected execution nodes and an object server selected from the plurality of object servers.

The node requesting the available service specifies said destination node.

The user interface can be installed in mobile telephone, smart phone, portable computer or any other type of user equipment.

Also disclosed is a method for delivering a multimedia service comprises the steps of receiving a request for a service, searching a list of available services in a register server for the service, analyzing the request to determine which available service is requested based upon the search and the service in the request, selecting one or more of a plurality of execution nodes to execute the service, establishing a chaining sequence between a node requesting the service, the one or more selected execution nodes and a destination node and executing the service.

The method further comprising the steps of creating an available service, registering the available service in said register server and storing the available service in said register server with an index. The available service can be a composite service that is executed by more than one of the plurality of execution nodes.

If the available service is a composite service, the step of creating an available service comprises the sub-steps of selecting at least two available services to create a composite service; and generating script for the composite service. The composite service is an aggregate of the at least two available services. The script provides an order for chaining the at least two available services.

A list of available services is provided to a user equipment device. The list is updated when a new service is registered. The list allows a user to find and select an available service.

### BRIEF DESCRIPTION OF THE FIGURES

These and other features, benefits, and advantages of the present invention will become apparent by reference to the following figures, with like reference numbers referring to like structures across the views, wherein:

FIG. 1 illustrates a block diagram of a network in accordance with the invention;

FIG. 2 illustrates an example of a method for registering a service into the multimedia overlay network in accordance with the invention;

FIG. 3 illustrates an example of a method to create a new composite service into the multimedia overlay network in accordance with the invention;

FIG. 4 illustrates a flow chart of steps for providing a multimedia service in accordance with the invention;

FIG. 5 illustrates an exemplary user interface used to generate an accessible service in accordance with the invention;

FIG. 6 illustrates an exemplary mashup portal used to generate a composite service in accordance with the invention; and

FIGS. 7A and 7B illustrate an exemplary activator screen progression for selecting a service.

### DETAILED DESCRIPTION OF THE INVENTION

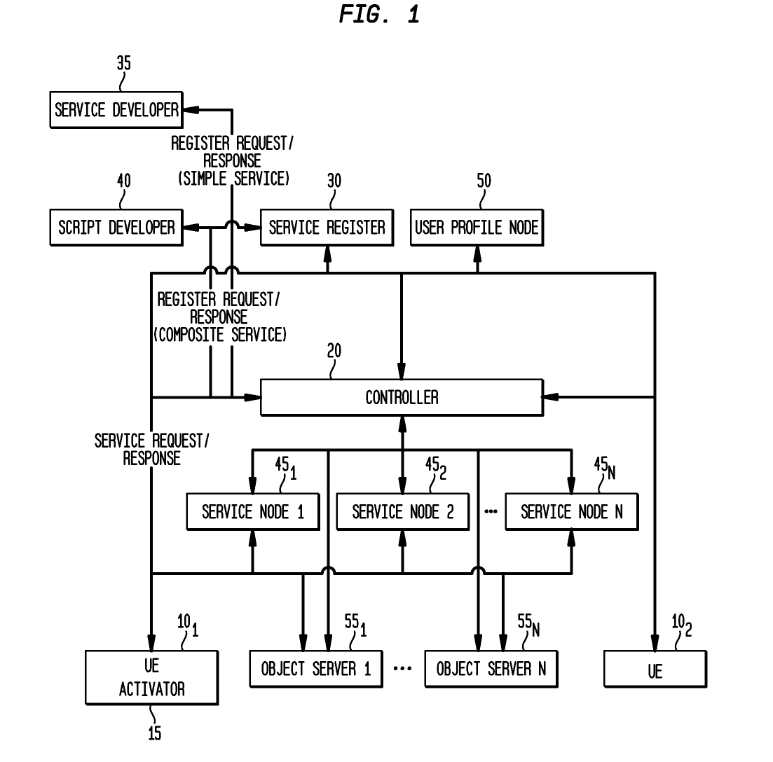

FIG. 1 illustrates a diagram of a multimedia overlay network 1. The multimedia overlay network 1 is an overlay network on top of a plurality of underlying networks to provide a multimedia service. The multimedia overlay network 1 can be used over all IP network or in conjunction with different type of existing underlying networks (e.g., IMS, P2P, Web, etc). The multimedia overlay network 1 is independent of the types of underlying networks. It utilizes the underlying networks to deliver a multimedia service. Additionally, the plurality of service nodes 45, as will be described herein can be a part of the underlying networks.

The multimedia overlay network 1 includes a controller 20, a service register 30, a service developer 35, a script developer 40 and a plurality of service nodes 45_{N}, a user profile node 50 and object servers 55. The multimedia overlay network 1 facilitates the execution of a plurality of services for user equipment 10_{N}. The services can be a simple service that can be executed by one service node, e.g., SN1 45₁. Alternatively, the service can be a composite service that requires multiple service nodes 45_{N} to execute the service. Each SN would execute a portion of the composite service. The services can run both on Internet (e.g., email, RSS) and on telecommunication networks (e.g., call control, location, presence, VoIP).

The controller 20 serves as the network manager. It is the primary point of contact in network, e.g., network cloud, for other network nodes and the end-user. When an end-user would like to access services, a service request is first sent to controller 20. Similarly, when a third party develops a new service component and would like to register this service component (i.e., its functionalities) into network cloud a register request is sent to controller 20. The controller 20 manages the execution of service scenario composition, service chaining for composite services, application and services nodes (SNs) discovery, and session or data path establishment between components and/or service nodes (SNs). In other words, the controller 20 controls data relay between SNs 45 and defines a binding method between them. For example, the binding method can be based on Service Component Architecture (“SCA”) concepts. Service Component Architecture is known and will not be described herein in detail.

The controller 20 does not reside on a multimedia data path during actual data delivery. However, the controller can be used to track of ongoing service requests, service progress and for self-organization. It provides a unified way to manage static and dynamic information of service nodes as well as monitoring of service components. For example, if several end-users are using the same service component, it may become overload and/or run out of capacity, the controller 20 can assign a functional service from one service node SN₁ 45₁ to another service node (SN₂) 45₂ for load balancing perspective. Service nodes are discussed below. Additionally, when a SN 45 is not working or responding, an alternative SN 45 can be assigned by the controller 20 to step-in to handle the service request.

As depicted in FIG. 1, the controller 20 is a single network entity; however, the functionality of the controller 20 can be divided into a plurality of decentralized network nodes.

Service Nodes (SNs) (collectively referenced is SNs 45) are network entities or nodes which include hardware and software hosting a service component. A Service Component (SC) includes an interface and can run in isolation or a part of a service chain. For example, in a media transcoding scenario, a transcoder service component is a functional component capable of video transcoding. Alternatively, the SN 45 can host more than one SC.

A user equipment 10 can be any device having access to a subscriber network, such as but not limited to, a cellular telephone, PDA, smartphone, television, personal computer, laptop, and the like. The user equipment 10 is configured with an Activator 15. The Activator 15 is used by the end-user to request access to multimedia overlay network 1 and obtain available services.

The activator can be a graphical user interface (GUI). The Activator 15 is used to generate service queries (“Service Requests”) and instructions (e.g., launch a service, specify particular features, etc.). The Activator 15 can access the multimedia overlay network 1 via the controller 20. The controller 20 can upload a service catalog contained updated available services to the Activator 15. The communication between the Activator 15 and controller 20 is done via an API.

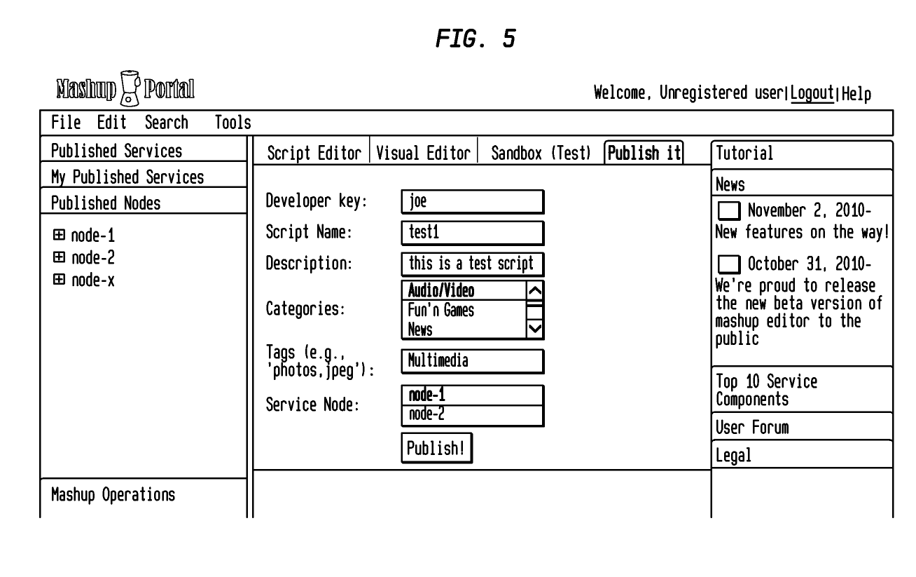

The service developer 35 is a node that is used to create and register SN 45 and its functionality into the multimedia overlay network 1. The service developer 35 includes a web console or browser that is an interface for a third party service provider, Telecom operator or user to enter a new SN 45 and service. The script developer 40 is a node that is used to aggregate registered SN and its functionality into a composite service and register the composite service into the multimedia network. The script developer 40 includes a web console or browser that is an interface to aggregate services to create a new composite service. Third party service providers and of course telecom operators can contribute and register their service components using the service developer 35 and script developer 40. FIG. 5 illustrates an example of a web console for registering a composite service in accordance with the invention. For example, a web console can include a list of available SNs 45 which can be aggregated, indexed by node identifier and service and a script editor section used to create a script. The script editor section can have multiple drop down selected fields, including but not limited to developer name, script name, a brief description of the service, a category(ies) of tag and a selected SN 45 to aggregate and script.

The simple or composite services are registered and stored in a service register 30. The simple and composite services are indexed for search and retrieval. While FIG. 1 illustrates the service register to be a separate network node, the service register can be integrated into the controller 20.

Each node communicates with other nodes in the multimedia overlay network via an interface. For example, a Service Request and Response interface (i.e., between Controller 20 and UE 10) allows end-users to access and receive an available service (e.g., register, request a service, publish content, etc.). The Service Control interface (i.e., between controller 20 and SNs 45) are used to set signaling paths (service routing), register service components and request service composition. The controller 20 also retrieves information about existing or registered SNs 45 using this interface. A session interface is used for service access between UEs 10 and SNs 45 as well as between different SNs for composite services.

In order to access the multimedia overlay network 1 and use any services, an end-user (UE 10) must be registered. The registration process can be an offline subscription process. Only subscribed users (UEs 10) can send a service request to the multimedia overlay network 1. A user or UE 10 must be authenticated first before to access any services. Authentication and authorization of users and services are supported in the multimedia overlay network 1 through Identity Management (IDM) Functional Entity (not shown). Alternatively, the controller 20 can serve as the IDM Functional Entity.

The user profile node 50 maintains an active list of user profiles for subscriber and a list of capabilities for UEs 10 and/or home subscriber network. The user profile includes a home subscriber network for the user/UE and network identifier for the UE. The capabilities for the UE can be object format for the device, e.g., preferred format for audio and video files. The network capabilities include the available bandwidth.

The object servers 55 store multimedia files and object that are subject to the requested services, such as but not limited to, streaming videos, files, pictures, text messages, data files, etc. An object server can be a UE 10 storing a multimedia data file.

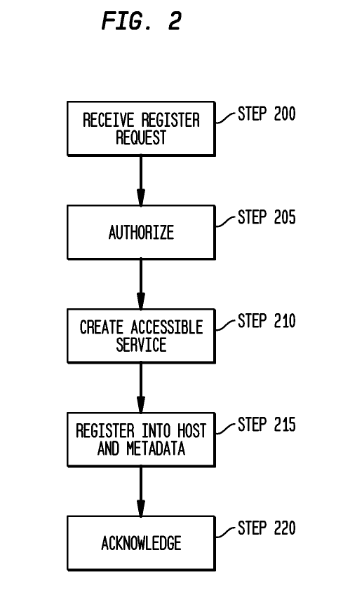

FIG. 2 illustrates a method for registering a service. A service can be registered into the multimedia overlay network 1 using the service developer 35 before it is made available for user access. Either service/application developer, network operator (or service provider) or end user performs registration of the service in multimedia overlay network 1. Static and dynamic information of service must be maintained. This information is important since the controller 20 will use it when a service request is received in order to establish service chaining order (availability and ordering). The controller 20 needs to store, retrieve, update, and delete dynamic information of service. At steps 200-205, a registration handshake is performed between the service developer 35 and the controller 20. A register request is issued by the service developer at step 200. The register request includes an identifier for the controller 20 for routing. Effectively, the register request is a system login. The controller 30 authorizes the request and responds with a register response at step 205. The authorization can include matching a source of the request with a list of authorized service developers 35, i.e., IP address. At step 210, an accessible service is generated. FIG. 5 illustrates an exemplary user interface used to generate an accessible service in accordance with the invention.

The service/application developer, network operator (or service provider) or end user enters information into preset fields. For example, the preset field can be, but is not limited to: name of developer, tag name for service, type of service, brief description of service, IP address of service components which handle the service, status of service, etc. Any of these fields can be used in the controller 20 to search for a service when the controller 20 receives a service request.

The preset fields can be sent in the register request, where the register request includes a plurality of attributes.

The attributes used in the register request can be a class, a desc, a first status and a second status and id, expires, contact address, and port, vender, input form, output form, protocol, node infor and format etc. The class is used to describe the type of service supported by the SN 45. Once registered, the controller 20 will use the class attribute to retrieve information about the service supported by a SN 45. The desc is a description of the service or function supported by the SN 45. The first status (for Register Request) is the current status of the service. It can be ready, running, success, failed or stopped. The second status (for Register Response) is registered or failed to register. The id is the service component id assigned by the controller 20. The id is included in the register response. The expires parameter is used to specify a duration of the registration. When the registration is about to expire, the SN 45 can decide to refresh its status. When the “expire” value is zero the SN 45 is requesting to be deregistered. The contact address is the IP address of the node sending the register request, e.g., SN. The contact port is the port number of the node sending the register request, The vender is the hostname, server provider or network operating hosting the SN 45. The input is type or format of data a SN 45 receives and can process. The output is the output format of the processed data received by a SN 45. The protocol is the protocol used for the service and format is the media format for the media operable for the service. Node_infor is the capability of the SN. Additional fields can be used, such as, but not limited to, defining messaging.

A service can also be deregistered from the multimedia overlay network 1. When the provider or SN 45 would like to deregister from the multimedia overlay network 1, it sends a Service Deregister Request. The information and service is removed and flushed from the service register 30.

The input information is transmitted to the controller 20 to register into the service register 30, at step 215. Alternatively, the information can be directly transmitted to the service register 30. Responsive to the receipt of the service information, the service register 30 formats it and includes the service in the list of available services, e.g., service registry. Upon completion, an acknowledgment is transmitted by the controller 20 (or service register 30) to the service developer 35 at step 220.

The service register 30 or controller 20 can also include a priority or ranking system. Alternatively, a separate ranking server can be used. The ranking system can be used by the controller 20 to optimize selection of SN 45 to be assigned for a given service request. This ranking system may be based on user feedback with higher incentives for providing information about high quality or reliable SN(s) 45.

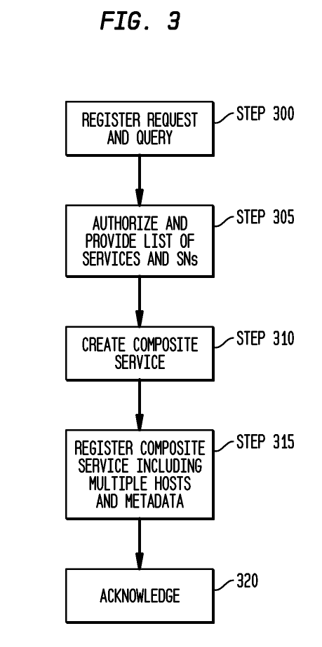

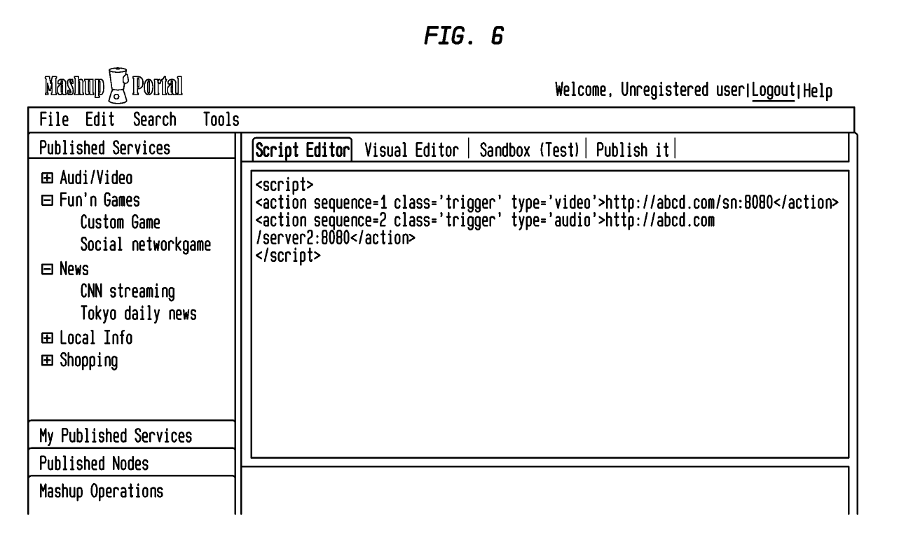

A new composite service can be created using the script developer 40. FIG. 3 illustrates an example of a method to create a new composite service. Similar to creating a new SN 45 and service, at steps 300 and 305, a handshake between the script developer 40 and controller 20 occurs. A composite register request is issued by the script developer at step 300. The composite register request includes an identifier for the controller 20 for routing. The controller 30 authorizes the request and responds with a register response at step 305. The register response can be a list of available services and SNs 45 to select from and aggregate. As described above, the script developer 40 includes a web console. The list of available services and SNs 45 is made available via the web console. This web console can be a mashup portal. FIG. 6 illustrates an exemplary mashup portal.

At step 310, a composite service is generated. The service/application developer, network operator (or service provider) or end user enters information into preset fields. The developer browses the available SNs 45 and services and selects a set of individual services to aggregate into the composite service. The developer then writes a script for executing the composite service. The script can be written in any web based language such as, but not limited to XML. The script development can be done using a GUI interface, in which the developer can use multiple drop down menus to select how component services can be aggregated together. The information can include, but not limited to, a developer name, a script name, a brief description of the service, a category(ies) of tag and a selected SN 45. Once all of the information is provided, the developer uploads the composite service to the multimedia overlay network 1 and publishes it, at step 315.

The input information is transmitted to the controller 20 to register into the service register 30, at step 315. Alternatively, the information can be directly transmitted to the service register 30. Responsive to the receipt of the composite information, the service register 30 formats it and includes the composite service in the list of available services, e.g., service registry. Upon completion, an acknowledgment is transmitted by the controller 20 (or service register 30) to the script developer 40 at step 320.

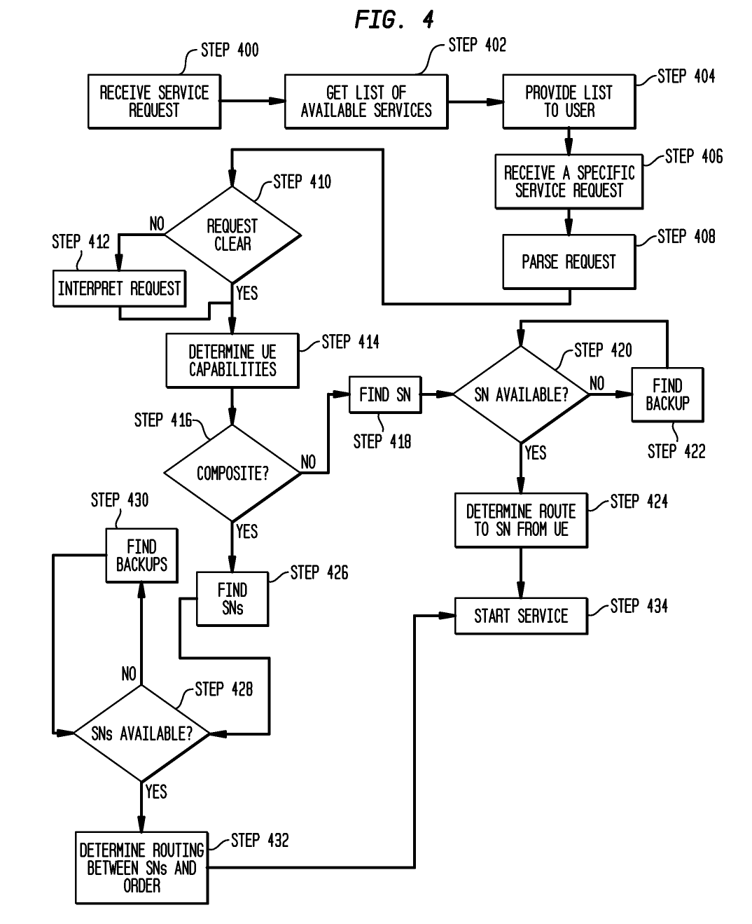

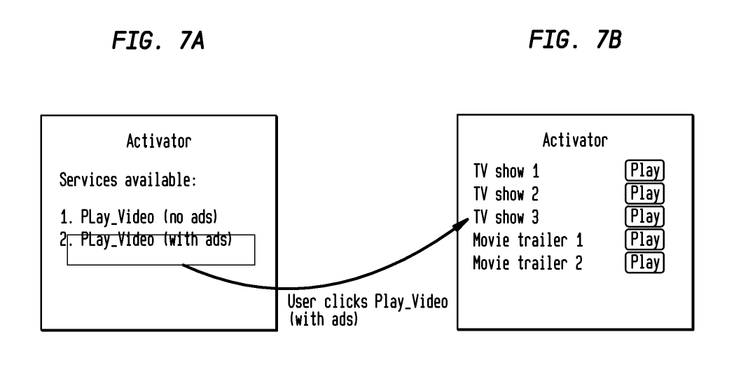

FIG. 4 illustrates a flow chart of steps for providing a multimedia service in accordance with the invention. At step 400, the UE 10 issues a Service request to the controller 20 via an activator. FIGS. 7A and 7B illustrate an exemplary activator screen progression for selecting a service. FIG. 7A is the first screen. FIG. 7B appears when the user selects the second option which is play video with ads. The second screen lists all available videos with ads, e.g., same type.

The service request can include a generic description of the desired service such as “streaming media”. Alternatively, the service request can be a request for any multimedia service. The request is input via the activator 15. For example, the service request can have an address, a phone number, a vendor, generic criteria, a tag, a title, a desc and a job. The address is the IP address of the UE 10. The phone number is the phone number of the subscriber. The vendor is the service provider or network operator. The generic criteria are the criteria the service requested should match.

At step 402, the controller 402 obtains a list of available services from the service register 30. If the service request included a generic description of the desired service, the controller 402 will query the service register 30 for only services that satisfies the generic search category, e.g., streaming media. The list is provided to the user at step 404 via the activator 15. The activator 15 formats the list for display. At step 406, the controller 20 receives a specific service request. The user via the activator 15 can select one of the plurality of services from the provided list, e.g., click on the service. Alternatively, the user can describe the service requested. The specific request includes a tags, title, desc and a job. The tag describes information about type of service and where the content can be found. The title has information about the specific service, i.e., the name and type. The desc: is the description of service type that will be displayed on end-user device. The jab is used as an ID for a given service request.

At step 408, the controller 20 parses the service request to determine which of the available services that the user requested.

The controller 20 determines if the request is clear at step 410. A request is clear if the description of the service matches the description in the service register 30 without a need for further interpretation. If the request is not clear, the controller 20 is programmed with logic and functionality to interpret the request based upon the description in the request and the description searches the service register 30 for a matched service using the programmed logic.

At step 414, the controller 20 obtains a user profile for the UE 10 and determines the capabilities of the UE 10. The controller 20 obtains the profile and capabilities from the user profile node 50. The user profile node 50 maintains a current user profile and a list of capabilities for the UE 10. The list of capabilities for the user includes a preferred file format for the media, such as PEG, MPEG-4, AVI, MP-3, etc., the size of a display, a number of pixels in the display. The user profile includes the home subscriber network for the user, e.g., telecommunication network.

At step 416, the controller 20 determines if the requested service is a composite service. A composite service is a service that requires multiple SNs 45. A composite service can be registered as a composite service. Additionally, a composite service can be registered as a single service and require one or more conversions due to format and size compatibility issues with the UEs 10. For example, the controller 20 uses the profile and list of capabilities to ensure that the multimedia service is provided to the UE 10 in a useable manner for the device. The specific SN 45 and service will depend on the user profile and capabilities. For example, if the desired service is streaming a media file, the file might need to be converted in format and transcoded, one SN1 might perform the conversion and a second SN2 might perform the transcoding and a third SN3 might perform the screaming (two SNs might perform the converting and transcoding, if the conversion and transcoding process requires an intermediate conversion step). If a file is required in format (Form1) and is stored in a remote server in a format (Form2), there might not be an available service that converts the file from Form2 into Form1. The available services can be converting the file from Form2 into Form3 and then converting the file from Form3 into Form1.

At steps 418 or 426, the controller 20 locates the needed SN(s) 45 (step 426 is performed if the service is composite and the controller 20 locates multiple SN). The controller 20 selects the required SN(s) based upon information in the service register 30. The service register 30 include a list of SNs 45 that correspond to a given service. Additionally, the controller 20 determines which SN to select based upon its interpretation of the service request. Once the service request is interpreted, the controller 20 can match the SN 45 with the requested service. Furthermore, if file needs to be converted or transcoded based upon information in the user profile and UE capabilities, the controller can select the appropriate SN 45 that corresponds to the conversion and transcoding necessary for the file. The controller 20 searches the service register 30 for the service and retrieves the SN(s).

At steps 420 or 428, the controller 20 signals the SN 45 to determine its/their availability (step 428 is performed if the service is composite and the controller 20 signal multiple SN). The controller 20 polls the SNs 45 to discover their load.

The controller 20 sends a service availability request message to check available service on SN 45. This request is issued upon reception of service request from the UE 10 and determination of the SN(s). When the controller 20 receives a request from activator 15, it generates a job number or ID that allows tracking this transaction. The SN 45 responds to service availability request by providing its capability for the service and the address or URL for the output associated with the SN 45.

The controller 20 sends a request to each SN 45, which can support service composition, in order to request availability of the service.

Upon receipt of the request from the controller 20, the SN 45 responds by providing its ability. The information in the request is copied into the response in order to track which request the response message is correlated. This is because the same job number can have multiple different requests to the same SN 45. Without specifying the requested information, the SN's response might be confusing.

The controller 20 can redirect services to different SNs based upon the available network resources and load at the SNs. This will avoid a flooding of a SN with too many UEs 10 requesting access to the same SN 45. If the SN is not available, e.g., too many UEs 10 accessing the SN 45, then a back up SN is located, at steps 422 and 430. The controller 20 will access the service register to determine another SN that is capable of performing the same service. The controller 20 will establish a routing chain between the other SN and the UE 10, after the controller 20 confirms the availability of the SN 45.

If the SN is available (at step 420), the controller 20 sets a route from the SN 45 to the UE 10₁. If the SNs 45 are available (at step 428), the controller 20 determines a processing order for the SNs 45 and sets a routing path between the SN 45 and a path between the final SN in the process and the UE 10₂. Additionally, if the object or multi-media file is remotely stored in the object servers 55, the controller 20 sets a routing path between the selected SNs 45 and the object server 55.

A service route request and response message is exchanged between the controller 20 and each of the SN(s) 45. After processing the service availability response messages, the controller sets up a service chaining (order) and notifies the SNs. The Service Route will contain the source address or URL of the previous SN 45 in the chain where data can be retrieved, i.e., object server 55 or UE 10. Further, an ACK message is used to confirm the route. The ACK message contains a status code of the requested service chaining sequence. If a SN 45 cannot reach the next hop in the service chaining sequence, it should set the status to failure for example due to network unreachability at IP layer. The service chaining sequence, i.e., plurality of SNs 45, can be connected using a one-hop signaling. Alternatively, multiple hops between SNs(s) can be used. These additional hops can traverse service routers (not shown). When the service router receives a message, it analyzes the message, by the way of resolving the destination service information (like service address, service type) and forwards the message to one or more immediate neighboring routers or SNs 45 on the way to its ultimate destinations, i.e., UE 10₂ or appropriate SN(s) 45.

The Service Response will contain the address or URL of the SN 45 where the UE 10 can retrieve or access the service.

After the routing is set at steps 424 or 432, the request service is started at step 434. If a first UE 10₁ issues a service request to send a file to a second UE 10₂ the route is set from the SN 45 to the second UE 10₂ not the requesting UE 10₁. Additionally, if the service request is to send a file to a second UE 10₂ user profile and the capabilities obtained is also for the second UE 10₂ not the requesting UE 10₁.

### Example 1

For example, suppose a user A wishes to send a video V to a user B. User B has a device that has different capabilities than user A. The user uses activator 15 to convey a service request to the multimedia network, e.g. controller 20. The controller 20 finds a series of SNs 45 that can assist in the delivery. The controller 20 obtains the user profiles and capabilities of both UEs for user A and B from the user profile node 50 and resolves the network conditions and types between users A and B and use this to affect the transcoding. In the event that UE B's device can support more than one transcoding, it may be that choosing one or the other further optimizes network usage. Based upon the information from the user profile node 50 and the requested service, the controller 20 finds an SN 45 that does transcoding via the service register 30. Perhaps coding C3 is required for user B but the initial encoding was in C1. Not finding an SN that encodes from C1→C3 the system finds SN1 that transcodes from C1→C2 and SN2 that transcodes from C2→C3 and invokes these in the correct order. Finally, the video is sent (e.g., streamed or just cached/posted in stateless fashion) from SN2 to the user B's UE. Controller 20 establishes tunnel between transcoder and streaming nodes.

User B views the video intended for him by user A. The video is viewed in a format that reflects both B's device's capability as well as the network capability (e.g., the transcoding may have been chosen to optimize network utilization or to optimize user experience).

The controller 20 can also reconfigure relevant SN 45 in case of dynamic situations, for example if User B roams to another network. The controller 20 continuously monitors the service and can dynamically change the SN 45.

### Example 2

The multimedia overlay network 1 can be used to send image and photograph where the photograph is tagged or annotated. Image annotation is the process by which objects in photographs are identified and tagged. The photograph can be tagged by drawing a box around an object. Subsequently, viewers of the photo can hover over the box and see how the user tagged a particular object (a “region”) in the photo. This tagging is used primarily to identify the people posed in photos or landmarks. Similarly, most high-end digital cameras (perform some degree of image recognition and tagging—for example cameras can perform image analysis to detect smiles on faces and triggers the shutter only when one is detected; another basic tagging mechanism is the ability to geo-tag photos with latitude and longitude, which many cameras do automatically (and which can also be done on photo-sharing sites).

For example, the photograph can be automatically tagged and recognized with SN(s) 45, where the UE 10 is not capable of performing the function. Additionally, the photograph can be tagged while the image is in transit from one user (a sender) to another (a recipient), e.g., “UE 1” (sender) and “UE 2” (recipient). A user takes a photograph of something with UE 1, such a particular building in Paris. The user wants to send the photograph to a friend or family member but would like the image to carry a bit more information. The user issues a service request via the activator 15 on UE 1 to start the process of annotating and sending the photo to a particular recipient(s). The controller 20 determines the request service and SN(s) 45 based upon the issued service request and information in the service register 30. A routing path is established for the service between UE 1 and the SN(s) and eventually to UE 2. The UE 1 transmits the photograph to the first SN 45 on the routing path if there is more than one SN 45 in the path. The SN 45 performs image analysis on the photograph, extracting recognizable objects and tagging those objects. When the SN 45 has completed the image analysis, the controller 20 informs UE 2 that a new annotated image is inbound and a session may be setup for the UE 2 to receive the media. Once the session is established for UE 2, a route from the SN 45 (or last SN within the route) to UE 2 is generated by the controller 20. UE 2 then receives and views the image and understands the tagging. Additionally, if the UE 1 has a camera with GPS encoding, the GPS can be added to the photograph by an SN 45. Additionally, an audio description of the photograph can be merged with the photograph by another SN.

### Example 3

The multimedia overlay network 1 can also be used for text and language message translation. The mass adoption of communications tools allows millions of people to instantly reach and communicate with each other, e.g., IM. Sometimes, even though actually sending the messages is not problematic, people with differing first languages desiring to communicate have problems understanding each other. In addition, the massive use of SMS and chat tools has resulted in an abbreviated way of expressing thoughts certain recipients might have difficulty understanding. A user with a mobile or desktop chat client can communicate not only with a particular friend, but also with a group of folks whose mother tongue is not his own. The activator 15 can issue a service request for a translation to the controller 20. The controller 20 locates the appropriate SN 45 from the service register 30 and establishes a routing path between an SN 45 (or set of SNs) and the UE 10. The UE 10 sends the message to the SN 45 for translation, identifying the recipients. Appropriate translation SN(s) 45 is/are found based upon the recipients' user profile and UE capabilities. The controller 20 obtains the users profile and UE capabilities from the user profile node 55. The SN(s) 45 translates the original message into multiple other messages depending on the profile of the recipient(s). Multiple SNs 45 can be used depending on the language that is needed. When the message is ready the recipients are informed by the controller 20. A multimedia session is established for the recipient UE(s) 10. A route from the appropriate SN 45 to the recipient UE is created and message is delivered.

Additionally, if a user sends a textual message to another user using a particular shorthand notation that may or may not be understood by the recipient the message will need to be translated. The user names the recipient(s) and issues a service request to the controller 20. The controller 20 obtains the users profile and UE capabilities from the user profile node 55 for the recipients and then selects appropriates SN(s) 45 to perform the translation from the service register 30. The controller 20 establishes the route between the requesting UE, i.e., UE 10 and the SN(s). The message is then sent to the first SN 45 in the route (if more than one). The SN 45 expands the shorthand into a form that is more understandable. Optionally, a second SN (language translation) can be used to convert from the language of the originator to the language of the recipient. The flow between SNs could be:

UE 10 (message)→SN1 (shorthand)→SN2 (language)→SN1 (shorthand)→SN2 (language)→SN3 (transmission).

The SN3 would then forward the message to the recipient once a session is established. When the message is ready the recipients are informed by the controller 20. A multimedia session is established for the recipient UE(s). A route from the appropriate SN 45 to the recipient UE is created and message is delivered.

### Example 4

The multimedia overlay network 1 can be used to deliver emergency communications. The first user can be involved in a session with another user, e.g., a VoIP session or video conference, where the controller 20 established the service and is monitoring the session. The users are known to the controller 20. At some moment an official user (policeman, mayor's office, department of security, public authority, etc.) formulates an alert that should be heard by a large number of mobile users whether they are in session or not. The UE 10 for the official user issues a priority service request to the controller 20. The controller 20 identifies the appropriate SN(s) from the service register 30 and establishes a routing path from the UE 10 to the SNs. The emergency message contents (the text) and its metadata are transmitted from the UE 10 via the activator 15 and sent to the appropriate SN 45. A SN 45 receives the message and resolves the endpoints into a series of addressable endpoints, and determines the presence of each endpoint.

For users whose UE 10 are not in session the controller 20 forwards the user details to one or more SN's in parallel who can create either a SIP message or a voice session with those endpoints—voice sessions play a pre-recorded media file or play the spoken translation of the textual message provided by the emergency personnel. If the UE 10 is already in a session, the current session is temporarily terminated so that the emergency session can start.

If an end-user is deemed not available at a given endpoint the SN might attempt to try another reachability mean the user has specified in the user profile. Additionally, if the UE 10 is already in session, prior to termination of the session, voice or text announce can be used to alert the user of the emergency message. For example, a caller ID (e.g., phone number and/or name) can be displayed. Additionally, the callee can decide to not take this call, although this might be an important call from family members, friends, etc.

### Example 5

The multimedia overlay network 1 can be used to deliver location and user requested information. For example, a user arrives at a new location, e.g., take off of a plane. The user can issue a search request via the activator 15 for local information such as, but not limited to, weather, tourist attractions, restaurants, movies, travel information, traffic, addresses to friends or GPS information. Each request or separate information can be provided by a separate SN 45 in combination with an object node 55. Each SN will append its set of information to a data file. The last SN will have an aggregated data file with all of the requested information. Similar to the other examples, the controller 20 will locate the appropriate SNs 45 based upon the specific request and the information from the service register 30. A route between the UE 10 and the last SN and a route between successive SNs 45 will be created and maintained.

The SNs 45 assemble and stream relevant information to the UE 10 that is contextualized and personalized.

Additionally, the information may be gathered in parallel by a number of SNs 45. A SN 45 that has a map provider function may be used to plot the location of buddies on a graphical map, rendered for the user. The user receives a series of information pages and information streams to his UE 10 that are highly contextualized to his current location.

### Example 6

The multimedia overlay network 1 can be used for media continuity, where a session was establish with a first UE (“UE 1”) and would like to be “paused” and continued on a second UE (“UE 2”).

For example, the user is watching a video on the UE 1 and the user arrives home and wants to continue watching the same video (possibly from the same spot in the video) on UE 2. The user can issue a service request on UE 1 via the activator 15 in order to continue the media on another named UE in the user profile. The controller 20 finds a SN that can read the URL, download a portion of the video in question, and store it based upon the information in the service register 30 and the service request. A different SN (“SN 2”) is then used to stream the media to the second UE 2. Another SN (“SN 3”) might be used to transcode the media into a size and format for the UE 2 based upon information provided by the user profile node 50.

Additionally, a SN 45 can simply inform the UE 2 (e.g., the Television) of the appropriate URL to click in order to resume the video (the URL may be designed to launch the video at a point in the middle, not from the start, necessarily).

Additionally, UE 2 can simply play the “last video seen” on the site from a given user account, which may be stored in an SN 45. Additionally, SN 45 and controller 20 can be used to find different posted segments of a media and sort them.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as “system.”

Various aspects of the present invention may be embodied as a program, software, or computer instructions embodied in a computer or machine usable or readable medium, which causes the computer or machine to perform the steps of the method(s) disclosed herein when executed on the computer, processor, and/or machine. A program storage device readable by a machine, tangibly embodying a program of instructions executable by the machine to perform various functionalities and methods described in the present disclosure is also provided.

The system and method of the present invention may be implemented and run on a general-purpose computer or special-purpose computer system. The computer system may be any type of known or will be known systems.

The above description provides illustrative examples and it should not be construed that the present invention is limited to these particular example. Thus, various changes and modifications may be effected by one skilled in the art without departing from the spirit or scope of the invention as defined in the appended claims.

What is claimed is:

1. A multimedia overlay service network comprising:
a user interface for subscribers to request an available service as a requested service;
a register server for registering and storing a database of available services;
a plurality of service nodes for executing at least one available service; and
a controller for receiving a request for an available service, searching the register server for the requested service, selecting one or more of the plurality of service nodes to execute the requested service and establishing a chaining sequence between a node requesting the service, the one or more selected service nodes and a destination node to execute the requested service.

2. The multimedia overlay service network according to claim 1, further comprising:
a plurality of object servers for storing objects which is subject to the available services, where each object server stores at least one object corresponding to an available service.

3. The multimedia overlay service network according to claim 1, further comprising:
a user profile node configured to maintain an active list of user profiles for subscribers and a list of capabilities for user equipment.

4. The multimedia overlay service network according to claim 3, wherein the controller continuously monitors a status of the execution of the request service.

5. The multimedia overlay service network according to claim 3, wherein the user profile node is further configured to store network capabilities and node capabilities for user equipment at the destination node.

6. The multimedia overlay service network according to claim 5, wherein the node capabilities include at least an object format capability for user equipment at the destination node.

7. The multimedia overlay service network according to claim 5, wherein the network capabilities include available bandwidth.

8. The multimedia overlay service network according to claim 1, further comprising:
a developer interface configured to provision services in the register server as available services, each provisioned service is indexed.

9. The multimedia overlay service network according to claim 1, further comprising:
a ranking service for prioritizing the available services.

10. The multimedia overlay service network according to claim 1, wherein the available service is a composite service that is executed by more than one of the plurality of service nodes.

11. The multimedia overlay service network according to claim 10, further comprising:
a script interface for a user to provision a script for the composite service, the composite service being an aggregate of at least two other available services, the script providing an order for chaining the at least two other available services.

12. The multimedia overlay service network according to claim 2, wherein the object is a multi-media file.

13. The multimedia overlay service network according to claim 12, wherein the multi-media file is a streaming video.

14. The multimedia overlay service network according to claim 12, wherein the node requesting the available service contains the multi-media file and the controller establishes a chaining sequence between the node requesting the service which becomes the object server for the requested service, the one or more selected service nodes and a destination node.

15. The multimedia overlay service network according to claim 13, wherein the node requesting the available service requests a service to stream a video, the controller establishes a chaining sequence between the node requesting the service which becomes the destination node for the requested service, the one or more selected service nodes and a selected object server selected from the plurality of object servers.

16. The multimedia overlay service network according to claim 2, wherein the controller selects a corresponding object server from the plurality of object servers and establishes a chaining sequence between at least the corresponding object server, the one or more selected service nodes and a destination node.

17. The multimedia overlay service network according to claim 1, wherein the node requesting the available service specifies the destination node.

18. The multimedia overlay service network according to claim 1, wherein the user interface is installed in mobile telephone.

19. A method for delivering a multimedia service comprising the steps of:
receiving a request for a service;
searching a list of available services in a register server for the service;
analyzing the request to determine which available service is requested based upon the search and the service in the request;
selecting one or more of a plurality of service nodes to execute the service; establishing a chaining sequence between a node requesting the service, the one or more selected service nodes and a destination node; and
executing the service.

20. The method for delivering a multimedia service according to claim 19 further comprising the steps of:
creating an available service;
registering the available service in the register server; and
storing the available service in the register server with an index.

21. The method according to claim 20, wherein the available service is a composite service that is executed by more than one of the plurality of service nodes.

22. The method according to claim 21, wherein the step of creating an available service comprises the sub-steps of:
selecting at least two available services to create a composite service; and
generating script for the composite service, the composite service being an aggregate of the at least two available services, the script providing an order for chaining the at least two available services.

23. The method for delivering a multimedia service according to claim 20 further comprising the steps of:
providing the list of available services to a user equipment device.

24. The method for delivering a multimedia service according to claim 20 further comprising the steps of:
providing updates to the list of available services when a new service is registered.
